(19) United States
(12) Patent Application Publication
(10) Pub. No.: US 2026/0064996 A1
(43) Pub. Date: Mar. 5, 2026

(54) SYSTEMS AND METHODS FOR REAL-TIME COMMUNICATION BETWEEN A PLURALITY OF USERS

(71) Applicant: 15677122 Canada Inc., Oakville (CA)

(72) Inventor: Ziran WU, Oakville (CA)

(21) Appl. No.: 19/307,135

(22) Filed: Aug. 22, 2025

Related U.S. Application Data
(60) Provisional application No. 63/688,048, filed on Aug. 28, 2024.

(51) Int. Cl. G06F 40/58; G06V 40/20

(52) U.S. Cl. CPC G06F 40/58; G06V 40/28

(57) ABSTRACT

Systems and methods for translating communications between two or more users who communicate in different languages. A first user provides input communication data to their electronic device in a first spoken language data or a first signed language data. The input communication data is converted from audio and/or video data into an input communication transcript in a first written language. The input communication transcript is then translated into an output communication transcript in a second written language. The output communication transcript is used to generate output communication data in a second spoken language or a second signed language that is understandable to a receiving user. The output communication data is provided to the receiving user's electronic device where it can be output to the receiving user.

### CROSS-REFERENCE TO RELATED APPLICATIONS

This application claims priority to U.S. Provisional Ser. No. 63/688,048 filed Aug. 28, 2024 and titled “SYSTEMS AND METHODS FOR REAL-TIME COMMUNICATION BETWEEN A PLURALITY OF USERS”, the entire contents of which are hereby incorporated by reference for all purposes.

### FIELD

The present disclosure relates to providing communication between users of electronic devices, and in particular, to methods and systems for translating communication data between users communicating in different languages.

### BACKGROUND

The following is not an admission that anything discussed below is part of the prior art or part of the common general knowledge of a person skilled in the art.

United States Patent Publication No. 2021/0352380 A1 of Duncan et al. purports to disclose a computer-implemented method for transforming audio-video data that includes automatically detecting substantially all discrete human-perceivable messages encoded in the audio-video data, determining a semantic encoding for each of the detected messages, assigning a time code to each of the encodings correlated to specific frames of the audio-video data, and recording a data structure relating each time code to a corresponding one of the semantic encodings in a recording medium. The method may further include converting extracted recorded vocal instances from the audio-video data into a text data, generating a dubbing list comprising the text data and the time code, assigning a set of annotations corresponding to the one or more vocal instances specifying one or more creative intents, generating the scripting data comprising the dubbing list and the set of annotations, and other optional operations. An apparatus may be programmed to perform the method by executable instructions for the foregoing operations.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

The present disclosure provides systems and methods for translating communications between two or more users who communicate in different languages. A first user provides input communication data to their electronic device in a first language (i.e. a first spoken language data or a first signed language data). The input communication data is converted from audio and/or video data into an input communication transcript in a first written language. The input communication transcript is then translated into an output communication transcript in a second written language. The output communication transcript is used to generate output communication data in a second language (i.e. a second spoken language or a second signed language) understandable to the receiving user. The output communication data is provided to the receiving user's electronic device where it can be output to the receiving user.

The input communication transcript may be translated into multiple output communication transcripts in different languages. The translation can occur substantially simultaneously to allow output communication data to be generated concurrently for multiple receiving users participating in a communication session. The translation systems and methods can thus integrate into various multi-party communication systems and environments, including standard person to person calls, conference calls and digital meeting rooms, as well as augmented and virtual reality environments.

In accordance with one aspect of this disclosure, which may be used alone or in combination with any other aspect, there is provided a method of providing real-time communication between a plurality of users communicating in a plurality of languages, wherein each user is associated with a corresponding electronic device, the method comprising: receiving, at a first electronic device associated with a first user, input communication data comprising the first user communicating in a first language, wherein the first language is a first spoken language or a first signed language; generating, from the input communication data, an input communication transcript in a first textual language; generating an output communication transcript in a second textual language by translating the input communication transcript from the first textual language to the second textual language, wherein the second textual language is different from the first textual language; generating, from the output communication transcript, output communication data in a second language wherein the second language is a second spoken language or a second signed language; and providing the output communication data to a second electronic device associated with a second user, wherein the output communication data is usable by the second electronic device to output the output communication data in the second language.

The input communication data can include audio input data that includes the first user communicating in the first spoken language.

The first textual language can be a written form of the first spoken language.

The input communication data can include video input data that includes the first user communicating in the first signed language.

Generating the input communication transcript can include analyzing the video input data to detect signed communication content of the first user communicating in the first signed language and translating the signed communication content into the first textual language.

The first textual language can be preselected by the first user.

Analyzing the video input data to detect the signed communication content can include inputting at least a portion of the video input data to a machine learning model trained to detect hand gestures associated with the first signed language.

Translating the input communication transcript from the first textual language to the second textual language can include identifying a plurality of first transcript syntactic blocks in the input communication transcript; and translating the plurality of first transcript syntactic blocks into the second textual language block by block.

The second language can be a second spoken language and generating the output communication data can include generating a synthesized voice speaking in the second spoken language.

The synthesized voice can be generated based on a first user voice sample received from the first user.

The synthesized voice can be generated by a first user machine learning model trained using the first user voice sample.

The first user machine learning model can be stored locally on the first electronic device.

The method can include detecting emotion data from the input communication data; and modifying the synthesized voice based on the detected emotion data.

The input communication data can include audio input data and detecting the emotion data in the input communication data can include: separating the audio input data into a plurality of audio input blocks; inputting the plurality of audio input blocks to a machine learning model trained to detect emotion in audio data; and defining emotion values based on the output from the machine learning model.

Detecting the emotion data can include determining an input sentiment value and an input intensity value.

The input communication data can include video input data and detecting the emotion data in the input communication data can include: analyzing facial characteristics of the first user in the video input data to detect video emotion data.

Analyzing the facial characteristics of the first user can include: defining first user facial landmark data by detecting facial landmarks of the first user in the video input data; and inputting the first user facial landmark data to a machine learning model trained to output the video emotion data based on facial landmarks.

The method can include generating at least one additional output communication transcript, wherein each additional output communication transcript can be generated in a corresponding additional textual language by translating the input communication transcript from the first textual language to the additional textual language; for each additional output communication transcript, generating corresponding additional output communication data in an additional language wherein the additional language is an additional spoken language or an additional signed language; and providing the additional output communication data to an additional electronic device associated with an additional user, where the additional output communication data is usable by the additional electronic device to output the additional output communication data in the additional language.

The method can include, for each additional output communication transcript, providing the additional output communication transcript in the corresponding additional textual language to the additional electronic device associated with the additional user using a different channel of a data transmission protocol used for providing the output communication transcription in the second textual language to the second electronic device.

The method can include providing the output communication transcript to the second electronic device associated with the second user using a different data transmission protocol than a data transmission protocol used for providing the output communication data to the second electronic device.

The method can include filtering the audio input data prior to generating input communication transcript in the first textual language.

In accordance with an aspect of this disclosure, there is provided a non-transitory computer-readable medium storing computer-executable instructions, the instructions being executable by one or more processors to perform a method of providing real-time communication between a plurality of users communicating in a plurality of languages, wherein each user is associated with a corresponding electronic device, the method comprising: receiving, at a first electronic device associated with a first user, input communication data comprising the first user communicating in a first language, wherein the first language is a first spoken language or a first signed language; generating, from the input communication data, an input communication transcript in a first textual language; generating an output communication transcript in a second textual language by translating the input communication transcript from the first textual language to the second textual language, wherein the second textual language is different from the first textual language; generating, from the output communication transcript, output communication data in a second language wherein the second language is a second spoken language or a second signed language; and providing the output communication data to a second electronic device associated with a second user, wherein the output communication data is usable by the second electronic device to output the output communication data in the second language.

The non-transitory computer-readable medium can further include instructions for performing a method as described herein.

In accordance with an aspect of this disclosure, there is provided a system for providing real-time communication between a plurality of users communicating in a plurality of languages, wherein each user is associated with a corresponding electronic device, the system comprising: a first electronic device associated with a first user; a second electronic device associated with a second user; and a server in communication with the first electronic device and the second electronic device; wherein the first electronic device is configured to receive input communication data comprising the first user communicating in a first language, wherein the first language is a first spoken language or a first signed language; at least one of the first electronic device or the server is configured to: generate, from the input communication data, an input communication transcript in a first textual language; generate an output communication transcript in a second textual language by translating the input communication transcript from the first textual language to the second textual language, wherein the second textual language is different from the first textual language; generate, from the output communication transcript, output communication data in a second language wherein the second language is a second spoken language or a second signed language; and the server is configured to provide the output communication data to the second electronic device, wherein the output communication data is usable by the second electronic device to output the output communication data in the second language.

The input communication data can include audio input data that includes the first user communicating in the first spoken language captured by the first electronic device.

The first textual language can be a written form of the first spoken language.

The input communication data can include video input data that includes the first user communicating in the first signed language captured by the first electronic device.

The at least one of the first electronic device or the server can be configured to generate the input communication transcript by analyzing the video input data to detect signed communication content of the first user communicating in the first signed language and translating the signed communication content into the first textual language.

The first textual language can be preselected by the first user.

The at least one of the first electronic device or the server can be configured to analyze the video input data to detect the signed communication content by inputting at least a portion of the video input data to a machine learning model trained to detect hand gestures associated with the first signed language.

The at least one of the first electronic device or the server can be configured to translate the input communication transcript from the first textual language to the second textual language by identifying a plurality of first transcript syntactic blocks in the input communication transcript; and translating the plurality of first transcript syntactic blocks into the second textual language block by block.

The second language can be a second spoken language and the at least one of the first electronic device or the server can be configured to generate the output communication data by generating a synthesized voice speaking in the second spoken language.

The synthesized voice can be generated based on a first user voice sample received from the first user.

The synthesized voice can be generated by a first user machine learning model trained using the first user voice sample.

The first user machine learning model can be stored locally on the first electronic device.

The at least one of the first electronic device or the server can be configured to: detect emotion data from the input communication data; and modify the synthesized voice based on the detected emotion data.

The input communication data can include audio input data and the at least one of the first electronic device or the server can be configured to detect the emotion data in the input communication data by: separating the audio input data into a plurality of audio input blocks; inputting the plurality of audio input blocks to a machine learning model trained to detect emotion in audio data; and defining emotion values based on the output from the machine learning model.

The at least one of the first electronic device or the server can be configured to detect the emotion data by determining an input sentiment value and an input intensity value.

The input communication data can include video input data and the at least one of the first electronic device or the server can be configured to detect the emotion data in the input communication data by: analyzing facial characteristics of the first user in the video input data to detect video emotion data.

The at least one of the first electronic device or the server can be configured to analyze the facial characteristics of the first user by: defining first user facial landmark data by detecting facial landmarks of the first user in the video input data; and inputting the first user facial landmark data to a machine learning model trained to output the video emotion data based on facial landmarks.

The at least one of the first electronic device or the server can be configured to generate at least one additional output communication transcript, where each additional output communication transcript is generated in a corresponding additional textual language by translating the input communication transcript from the first textual language to the additional textual language; for each additional output communication transcript, generate corresponding additional output communication data in an additional language wherein the additional language is an additional spoken language or an additional signed language; and the server can be configured to provide the additional output communication data to an additional electronic device associated with an additional user, where the additional output communication data is usable by the additional electronic device to output the additional output communication data in the additional language.

The server can be configured to, for each additional output communication transcript, provide the additional output communication transcript in the corresponding additional textual language to the additional electronic device associated with the additional user using a different channel of a data transmission protocol used for providing the output communication transcript in the second textual language to the second electronic device.

The server can be server is configured to provide the output communication transcript to the second electronic device associated with the second user using a different data transmission protocol than a data transmission protocol used for providing the output communication data to the second electronic device.

The at least one of the first electronic device or the server can be configured to filter the audio input data prior to generating input communication transcript in the first textual language.

It will be appreciated by a person skilled in the art that a system or method disclosed herein may embody any one or more of the features contained herein and that the features may be used in any particular combination or sub-combination.

These and other aspects and features of various examples will be described in greater detail below.

### BRIEF DESCRIPTION OF THE DRAWINGS

For a better understanding of the described examples and to show more clearly how they may be carried into effect, reference will now be made, by way of example, to the accompanying drawings in which:

FIG. 1 is a block diagram of an example computer network system that can be used to provide real-time communication between a plurality of users;

FIG. 2 is a block diagram of an example system for providing real-time communication between a plurality of users; and

FIG. 3 is a flowchart illustrating an example method of providing real-time communication between a plurality of users.

The drawings, described below, are provided for purposes of illustration, and not of limitation, of the aspects and features of various examples described herein. For simplicity and clarity of illustration, elements shown in the drawings have not necessarily been drawn to scale. The dimensions of some of the elements may be exaggerated relative to other elements for clarity.

### DETAILED DESCRIPTION

Various systems or methods will be described below to provide an example of the claimed subject matter. No example described below limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described below is not an example that is recited in any claimed subject matter. Any subject matter disclosed in a system or method described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The examples of the systems and methods described herein may be implemented as a combination of hardware or software. In some cases, the examples described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the examples described herein that may be implemented via software that is written in a high-level computer programming language such as object oriented programming or script-based programming. Accordingly, the program code may be written in Java, Swift/Objective-C, C, C++, Javascript, Python, SQL or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the examples described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. The computer program product may also be distributed in an over-the-air or wireless manner, using a wireless data connection.

The term “software application” “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled. Software applications may include mobile applications or “apps” for use on mobile devices such as smartphones and tablets or other “smart”devices.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs.

Software applications may be deployed to and installed on a computing device on which it is to operate. Depending on the nature of the operating system and/or platform of the computing device, an application may be deployed directly to the computing device, and/or the application may be downloaded from an application marketplace. For example, user of the user device may download the application through an app store such as the Apple App Store™ or Google™ Play™.

The present disclosure relates to systems and methods for providing real-time translation for users communicating through electronic devices. The systems and methods described herein can be used to facilitate and support interactions between users who communicate using different languages.

Language barriers present major challenges in many aspects of modern life. These challenges are particularly pronounced for spoken or signed communications, because these communications tend to occur in real-time and often lack a record of the communication that can be translated. Translation of these interactions, if available, tends to be time-consuming and labor intensive. The resultant translated communication data also tends to lack contextual data that can be determined from the voice and/or expression of the individual communicating in their original language.

The present disclosure provides systems and methods for real-time translation that allow users communicating through electronic communication systems (e.g. audio and/or video calling systems) to communicate with users who speak or sign a different language. The systems and methods described herein can provide users with a record of the communications being translated to ensure that the communication details are accurate. The systems and methods described herein can also provide translated communication data that conveys contextual information about the emotions and expressions of the original user.

A first user can provide input communication data to their electronic device. The input communication data generally includes audio and/or video data that includes the first user communicating in a first language (either a first spoken language or a first signed language). The input communication data can be converted into an input communication transcript in a first written language. Optionally, the first user can specify their corresponding first language prior to the communication session (e.g. to facilitate real-time translation and/or to ensure that communications from other users are translated into that first language).

An output communication transcript can be generated by translating the input communication transcript into a second written language. A separate output communication transcript may be generated for each receiving user who communicates in a different language (e.g. where there are more than two users on a call, the input communication transcript can be translated into different output communication transcripts for each user requiring a different output language). The output communication transcript can then be used to generate output communication data that can be provided to each receiving user through their respective electronic device. The output communication data can be presented to the receiving user by their electronic device in a language and form understandable to that user.

The output communication data can include audio output data in a second spoken language. The second spoken language can be preselected by a receiving user as the language in which they are comfortable communicating.

Alternatively or in addition, the output communication data may include video output data. For example, the video output data may include video data providing communications in a second signed language preselected by the receiving user. Alternatively or in addition, the video output data can also include contextual communication data, e.g. a representation of verbal or non-verbal contextual communication information.

Optionally, the output communication data can be defined based on analysis of the emotion and/or expression of the first user. For example, the audio input data and/or video input data can be analyzed to determine the sentiment and sentiment intensity of the first user. The sentiment and intensity values can be used when generating the output communication data to ensure that the full communication context can be conveyed to a receiving user. For instance, the audio output data and/or video output data can be augmented using the sentiment and intensity values.

Optionally, the audio output data can be generated into a synthesized voice that is defined based on a voice sample from the first user. The first user can provide a voice sample in the first spoken language. The voice sample can be used to train a synthesization model that generates the audio output data in a synthesized version of the first user's voice.

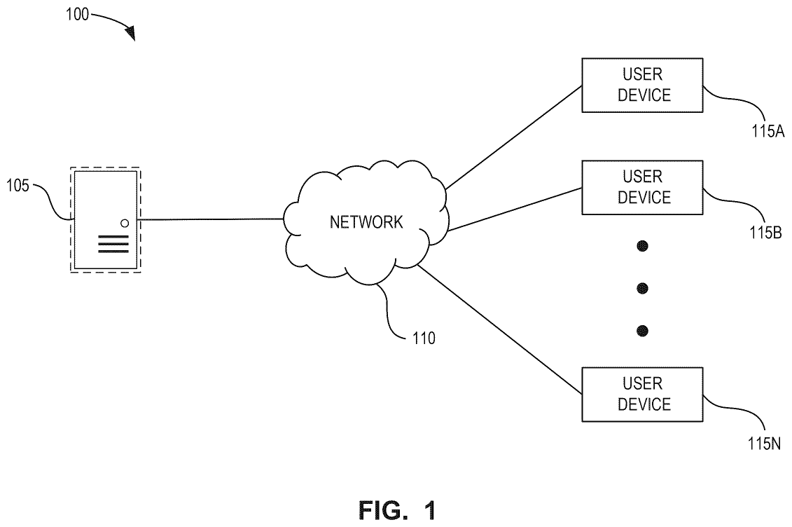

Referring now to FIG. 1, there is shown a block diagram of a computer network system 100 in accordance with an example. As shown, the computer network system 100 generally includes a server 105, a network 110 and one or more user devices 115A-115N connected via network 110.

Network 110 may include, or may be connected to, the internet. Optionally, the connection between network 110 and the Internet may be made via a firewall server (not shown). In some cases, there may be multiple links or firewalls, or both, between network 110 and the Internet. Some organizations may operate multiple networks 110 or virtual networks 110, which can be internetworked or isolated. These have been omitted for ease of illustration, however it will be understood that the teachings herein can be applied to such systems. Network 110 may be constructed from one or more computer network technologies, such as IEEE 802.3 (Ethernet), IEEE 802.11 and similar technologies.

Server 105 is a computer server that is connected to network 110. Server 105 has a processor, volatile and non-volatile memory, at least one network interface, and may have various other input/output devices. As with all devices shown in the system 100, there may be multiple servers 105, although not all are shown.

User devices 115 generally refer to electronic devices including desktop or laptop computers, smartphones, tablet computers, and may include a wide variety of “smart” devices capable of data communication. Like server 105, user devices 115 each include a processor, a volatile and non-volatile memory, at least one network interface, and input/output devices. User devices 115 may be portable, and may at times be connected to network 110 or a portion thereof.

As will be understood, a user device 115 may be any suitable computing device 115 capable of executing an application. For example, in various examples, the computing device 115 may include mobile devices such as smartphones, tablets or laptops, as well as less conventional computing devices such as: smart appliances; wearable computing devices such as smartwatches, smart glasses, and/or smart clothing; computers embedded into automobiles, cars or vehicles (e.g., as may have been provided for navigation and/or entertainment purposes).

Each of the user devices 115 can have a plurality of software applications operating thereon. The software applications can include a user communication application that enables audio and/or video communication between the device 115 and another device 115. Accordingly, each user device 115 generally includes a communication interface enabling the device 115 to access network 110, one or more input devices (e.g. a microphone, a camera), one or more output device (e.g. a speaker, a display), and a corresponding user communication application operable to support communication with a remote device (e.g. a call-connection application, a room-based communication application etc.).

In examples of the system 100, the server 105 can be configured to communicate with the user devices 115. The server 105 may request user data from the user devices 115 relating to user's preferred language (i.e. the language used by the user of that device) and optionally user voice data. The server 105 can receive from the user device 115 communication data for an ongoing communication session that the user is participating in. The server 105 can also provide to each user device 115 output communication data generated from the input communication data received from another user device 115 participating in the ongoing communication session.

Optionally, the server 105 can generate and train a user voice synthesization model using the user voice data received from the user device 115. The server 105 can store the trained user voice synthesization model for use in generating output communication data for communication sessions involving the corresponding user/user device 115. Storing the user voice synthesization model on server 105 (or a database accessible to server 105) can facilitate storage of a potentially large model. This can also facilitate real-time synthesization of audio data for the output communication data, as the server 105 is likely to have access to greater computing resources than a user device 115.

Alternatively or in addition, the server 105 can provide each of the user devices 115 with the trained user voice synthesization model corresponding to the user of that device 115. The server 105 can also provide the user device(s) 115 with any subsequent updates to the respective user voice synthesization model that may be generated.

Alternatively or in addition, the user device 115 can be configured to train and store a user voice synthesization model using user voice data input to the user device 115. Optionally, the voice sample and/or trained user voice synthesization model may be stored only on the user device 115 to enhance privacy and security for the user.

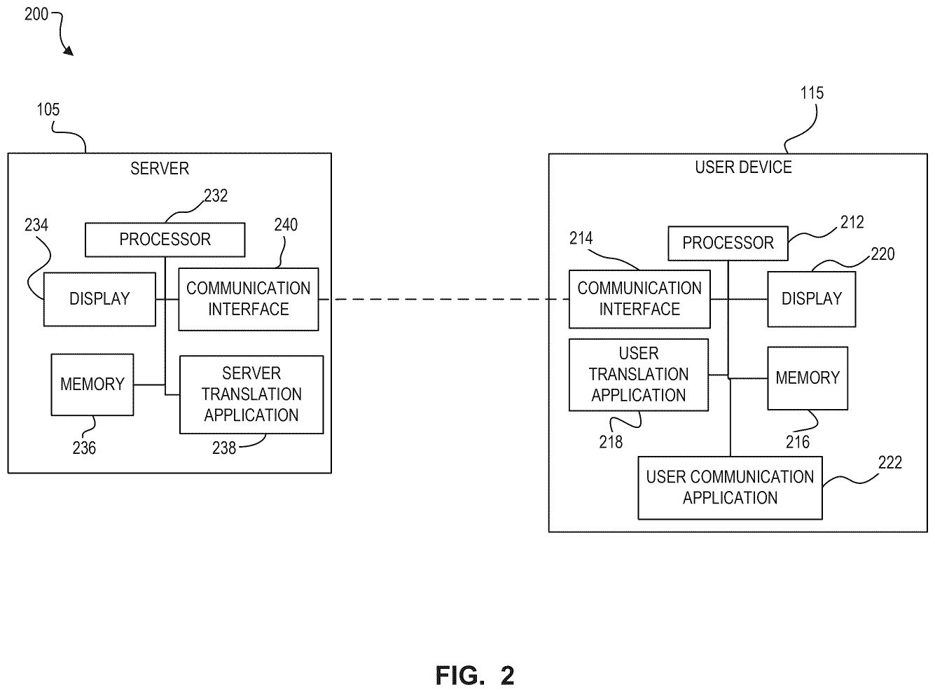

Referring now to FIG. 2, there is shown a block diagram of a system 200 for providing real-time communication between user devices, in accordance with an example. System 200 illustrates a more detailed example of components of the server 105 and a user device 115.

As in system 100, server 105 is a computer server that is connected to network 110. As shown in FIG. 2, server 105 can include a processor 232, a display 234, a memory 236, a communication interface 240 and a server translation program 238. Although shown as separate elements, it will be understood that the server translation program 238 may be stored in memory 236.

It will be understood that the server 105 need not be a dedicated physical computer for executing the server translation program 238. For example, in various examples, the various logical components that are shown as being provided on server 105 may be hosted by a third party “cloud” hosting service such as Amazon™ Web Services™ Elastic Compute Cloud (Amazon EC2). The logical components that are shown as being provided on server 105 can also be provided by multiple server computers operating in a collective or cooperative manner.

Processor 232 is a computer processor, such as a general purpose microprocessor. In some other cases, processor 232 may be a field programmable gate array, application specific integrated circuit, microcontroller, or other suitable computer processor.

Processor 232 is also coupled to display 234, which is a suitable display for outputting information and data as needed by various computer programs. In particular, display 234 may display a graphical user interface (GUI). In some cases, the display 234 may be omitted from server 105, for instance where the server 105 is configured to operate autonomously.

Communication interface 240 is one or more data network interface, such as an IEEE 802.3 or IEEE 802.11 interface, for communication over a network.

Processor 232 is coupled, via a computer data bus, to memory 236. Memory 236 may include both volatile and non-volatile memory. Non-volatile memory stores computer programs consisting of computer-executable instructions, which may be loaded into volatile memory for execution by processor 232 as needed. It will be understood by those of skill in the art that references herein to server 105 as carrying out a function or acting in a particular way imply that processor 232 is executing instructions (e.g., a software program) stored in memory 236 and possibly transmitting or receiving inputs and outputs via one or more interface. Memory 236 may also store data input to, or output from, processor 232 in the course of executing the computer-executable instructions. As noted above, memory 236 may also store the server translation program 238.

User device 115 is generally a mobile computer such as a smartphone, tablet, laptop or other “smart” device that may be networked through the “Internet of Things”. However, user device 115 may also be a non-mobile computer device, such as desktop computer. As shown, user device 115 has a processor 212, a communication interface 214 for data communication with communication interface 240 (and other user devices 115), a display 220 for displaying a GUI, and a memory 216 that may include both volatile and non-volatile elements. As with server 105, references to acts or functions by user device 115 imply that processor 212 is executing computer-executable instructions (e.g., a software program) stored in memory 216.

The user device 115 can include a user translation program 218. While the user translation program 218 is shown separately from memory 216, it will be understood that the user translation program 218 may be stored in memory 216. The user device 115 may also store a plurality of other software applications, such as a user communication application 222, in memory 216. The device memory 216 may generally store instructions which, when executed by the device processor 212 causes, the device processor 212 to provide functionality of the various applications stored thereon.

The user communication application 222 can be generally any form of application that enables the user device 115 to connect to one or more other user devices 115 to engage in an ongoing communication session (e.g. an audio call, video call, digital conference or meeting room etc.) and to transfer communication data in a bidirectional manner. Although the user translation program 218 is shown separately from the user communication application 222, it should be understood that the functionality of the user translation program 218 may be combined with or integrated into a user communication application 222 (e.g. as a combined communication and translation application and/or as a plug-in or extension of the communication application 222). Optionally, the user translation program 218 may be omitted and the user device 115 may simply communicate with server translation application 238 through the user communication application 222.

The user translation program 218 can be configured to communicate with the server translation application 238. For example, the user translation program 218 can configure a user interface on the user device 115 that enables a user to provide user data to the server translation application 238, such as user identification data (and optionally access credentials), user language data (e.g. the input language the user communicates in, the language the user desires to receive output communication in), user voice data (e.g. selecting a default synthesized voice from one or more default options, providing a voice sample to enable a cloned output voice). A user voice sample can be used by the user translation program 218 and/or server translation application 238 to train a voice cloning model (also referred to as a voice synthesization model) usable to synthesize an output voice that is a replica or clone of the user's voice.

The server 105 can, in turn, be configured to store various user data, such as user identification data, user language data, and/or user voice data in a database in memory 236. Storing the user language data on the server 105 (or at least receiving user language data for each participating user at or before the beginning of a communication session) can ensure that the server 105 is able to generate output communication data in the correct language for each user in a communication session.

Storing user voice synthesization models on server 105 (or a database accessible to server 105) can facilitate real-time synthesization of audio data for the output communication data to be sent to receiving users using the computing resources available to server 105. Alternatively, the user voice sample data and/or trained voice cloning model may be stored solely on the first user device 115 to provide a user with enhanced privacy.

In various examples, the user translation program 218 may be a standalone program (or software application) that is downloaded and installed on the user device 115. In other examples, the user translation program 218 may be integrated into a third-party software application, which itself, is downloaded and installed on the user device 115 (e.g., through an app store such as the Apple App Store or Google Play). Further alternatively, the user translation program 218 may be a cloud or web-based application accessible to the user device 115 over the network 110, e.g. using a browser application or the user communication application 222 operating on the user device 115.

An application developer may use a software development kit (SDK) associated with the present system 200 when writing source code for the user communication application 222. The SDK may include programming language units (e.g., class definitions, library functions, etc.) that are usable by a software developer to create user interface elements within the application 222 that may be able to communicate with the user translation program 218 and/or logical elements on the server 105. In some cases, a developer may use the SDK when developing or modifying the software application 222 to integrate the user translation program 218 into a new application or into an existing application.

In operation, the server translation application 238 and user translation application 218 can cooperate and exchange data to establish a communication session between the user device 115 and a second user device 115 (and optionally additional user devices 115). The server 105 can be configured to identify and authenticate the user devices 115 (and associated users) participating in a communication session for which the translation processes described herein are used.

Each user device 115 can be configured by the user communication application 222 to exchange signals and data with the server 105 and/or other user devices 115 to establish and maintain a communication session (using various communication sessions models, such as a call connection and/or link-based connection model).

The user translation application 218 and server translation application 238 can be configured to communicate using various data transmission protocols that allow for audio and/or video data to be transmitted rapidly. For example, one or more of a UDP-based data transmission protocol, a server sent events-based (SSE) data transmission protocol, or a WebSocket-based data transmission protocol may be used although other protocols may be used in different implementations of the present disclosure.

The server 105 can be configured to establish and maintain connections to a plurality of user devices 115 engaged in ongoing communication sessions, e.g. via sockets. The server 105 may also maintain a database or log of ongoing communication sessions. The server 105 can also store user data associated with the devices 115 participating in the communication sessions, e.g. user language data required to determine the second and additional languages into which input communication data is to be translated. The server 105 may also store user voice data associated with one or more devices 115 participating in ongoing communication sessions.

The user translation application 218 and/or server translation application 238 can also provide the user device 115 with access to various analysis and processing modules usable to facilitate real-time communication and real-time translation of communication data. Typically, the server 105 may store analysis and processing modules requiring increased storage space and/or processing speed as the server 105 is likely to have access to greater computing resources than devices 115. This also provides a centralized system that can be easily updated instead of requiring the user translation application 218 on each device 115 to be constantly updated to reflect changes and updates to trained models for example.

For example, the server 105 can store one or more emotion analysis machine learning models configured to output emotion data in response to receiving input communication data. For example, an emotion analysis machine learning model can be trained to receive as an input a block of audio input data and output an emotion value or tag (e.g. “angry”, “nervous”, “happy”, “sad”, etc.) and a corresponding intensity value for each emotion value or tag.

The server 105 can also store one or more noise filters. A noise filter can receive as an input a block of audio input data and output audio output data corresponding to the audio input data with reduced noise. For example, a confidence-based filter may be used although other types of filters may be used in different implementations of the present disclosure. In some embodiments, a minimum confidence threshold of 75% can be used for the confidence-based noise filter.

The server 105 can also store one or more transcription models. A transcription model can be trained to receive as an input a block of audio input data and a first written language identifier and output a text transcription corresponding to the audio input data in the first written language. The server 105 may also include a signed language transcription model or models that is/are configured to receive as an input a block of video input data and a first written language identifier and output a text transcription in the first written language corresponding to the signed language information identified in the block of video input data.

The server 105 can also store one or more translation models. A translation model can be trained to receive as an input a block of text data, an input language identifier (e.g. the first written language), and an output language identifier (e.g. a second written language) and output a second text transcription in the second written language.

The server 105 and/or user device 115 can store a voice synthesization model. The voice synthesization model can be trained to output audio data using a synthesized voice that is based on a default voice, a voice preselected by a user, and/or a voice sample from the first user. The voice synthesization model can be trained to receive as input a block of text and the language of the block of text and output audio data that synthesizes that block of text into audio in the synthesized voice. Optionally, the voice synthesization model may also receive as inputs emotion and intensity values and can be configured to modulate or modify the synthesized voice based on the emotion and intensity values.

During an ongoing communication session, a first user can provide input data (e.g. by speaking or signing in a first language) to the electronic device 115. The input data can be transmitted to the server 105. The input data can be provided to a transcription model to generate an input transcription corresponding to the input communication data. Optionally, the input data can be provided to an emotion analysis model to identify emotion values and intensity values associated with the input communication data. Optionally, the input data can be provided to a noise filter to remove noise from the input data prior to the transcription model. Removing noise from the input data can result in better quality transcriptions.

The server 105 can input the text data from the input transcript to a translation model usable to generate an output transcription in a second language. The server 105 may input the text data from the input transcript to one or more translation models as needed to generate different output transcripts corresponding to output languages of the other users participating in the communication session.

Optionally, the text data from the input transcript may be separated into syntactic blocks prior to being input to a translation model to facilitate translation. This can provide improved translation results for the output transcript.

Alternatively, the text data from the input transcript may be separated into time-based or link-based blocks. This may provide for a more consistent communication stream between devices 115.

The server 105 can transmit the output transcript(s) to one or more voice synthesization models and/or sign generation models to generate output communication data in a language understandable to a receiving user. The output communication data (e.g. audio output data corresponding to a second spoken language or video output data corresponding to a second signed language) can then be transmitted from the server 105 to the electronic device 115 of the other users participating in the communication session.

In addition to the components described above, the server 105 and the user device 115 may have various other additional components not shown in FIG. 2. For example, additional input or output devices (e.g., keyboard, pointing device, etc.) may be included beyond those shown in FIG. 2.

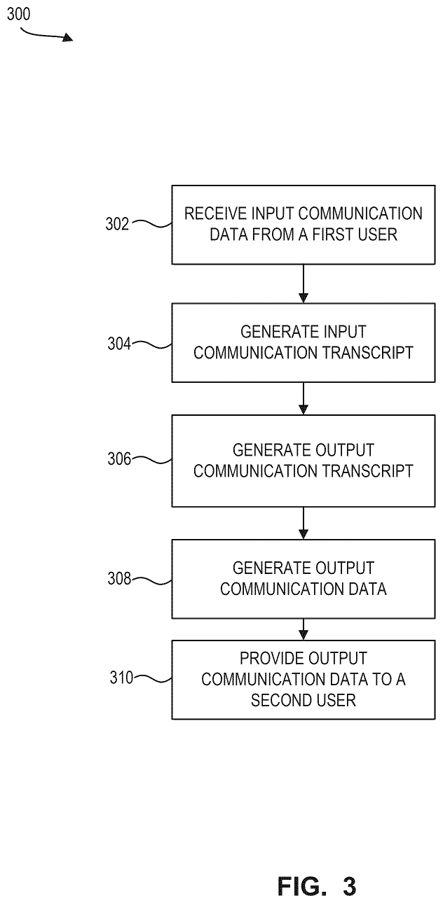

Referring now to FIG. 3, there is shown a flowchart illustrating a method 300 for providing communication between user devices 115, in accordance with an example. The method 300 may be carried out by various components of the systems 100 and 220, such as the user translation program 218 operating on a user device 115 and/or server translation program 238 operating on the server 105. The example method 300 shown and described herein can be implemented as a real-time translation process to facilitate real-time communication between users who understand different languages.

At 302, input communication data can be received at a first electronic device (e.g. user device 115). The first electronic device can be associated with a first user. The input communication data can include the first user communicating in a first language. The first language may be a first spoken language or a first signed language.

The input communication data can include audio input data and/or video input data. For example, the audio input data can include the first user communicating in a first spoken language. Alternatively, the video input data can include the first user communicating in a first signed language.

The input communication data can also include additional contextual communication data, e.g. sentiments and associated sentiment intensity that may be expressed by the first user beyond the core communication data that is provided in the first language. For example, the contextual communication data can be included in video input data (e.g. derived from expressions on the first user's face or other gestures and/or body language of the first user) and/or audio input data (e.g. derived from tone, intensity, and/or emphasis expressed by the first user).

At 304, an input communication transcript can be generated from the input communication data. The input communication transcript can be defined in a first textual language. The input communication transcript can be used to translate the input communication data into a different language that is understandable to a receiving user (e.g. a second user or additional user with whom the first user is communicating). The input communication transcript may also be used to provide the first user with a record of the information that is being translated to the receiving user (e.g. to enable the first user to ensure that their communication data has been correctly interpreted by the system 100/200).

As noted above, the input communication data received at 302 can include audio input data that includes the first user communicating in the first spoken language. In this circumstance, the first textual language can be a written form of the first spoken language.

Alternatively, the input communication data can include video input data that includes the first user communicating in a first signed language. The input communication transcript may then be generated by translating the signed communication content from the video input data into the first textual language. For example, the video input data can be analyzed to detect signed communication content of the first user communicating in the first signed language. The detected communication content can then be translated into the first textual language.

To detect the signed communication content, the video input data, or at least a portion thereof, can be provided as an input to a machine learning model trained to detect hand gestures associated with the first signed language. Gestures within the video input data can be identified, and then the identified gestures can be recognized as being associated with specific words or phrases in the first signed language. The associated words or phrases can then be translated into the first textual language.

For example, the first user's hands can be identified in the video input data using a hand landmark detection process, such as may be provided by MediaPipe. The output from the hand landmark detection process may then be provided as an input to a machine learning model (e.g. a TensorFlow model) trained to recognize specific gestures from the detected hand landmarks. The recognized gestures can then be mapped to corresponding words or phrases in the first textual language using a translation model for the signed language stored by the server 105 or user device 115.

Optionally, the first user may preselect the first textual language (particularly when the input communication data includes signed communication content). This may ensure that the input communication transcript is understandable to the first user (i.e. provides a meaningful record of the transcription understandable to the first user). Alternatively, the first textual language may be specified as a default first textual language that corresponds to the first spoken language or first signed language (e.g. the written form of the spoken language or a written language commonly associated with the signed language such as ASL and English).

In some embodiments, the generation of the input communication transcript at 304 can begin while the input communication data is being received at 302. For example, the input communication data can be received in a communication stream. Upon receipt of a first audio input block of the input communication data, a respective block of the input communication transcript can be generated while a second audio input block of the input communication data is received.

To reduce latency, the audio input blocks of the input communication data can be time-based blocks instead of sentence blocks, which can be delineated by audio pauses or breaks. The time-based blocks of audio input can correspond to a minimum viable block size. For example, the time-based blocks can be in the order of milliseconds although the time-based block can have another size in different implementations of the present disclosure.

The audio input blocks can be processed as soon as they become available. Optimal buffer parameters can be selected for immediate processing of the audio input blocks. For example, a very short time duration and buffer size can be allowed before timeouts. For example, a buffer timeout of 1 second and buffer size of 8 KB can be used, although the buffer can have other parameters in different implementations of the present disclosure.

To further reduce latency, multiple audio input blocks of the input communication data can be processed simultaneously, or in parallel. For example, three audio input blocks can be processed in parallel, although another number of audio input blocks can be processed in parallel in different implementations of the present disclosure

At 306, an output communication transcript can be generated in a second textual language different from the first textual language. The output communication transcript can be generated by translating the input communication transcript from the first textual language to the second textual language.

The second textual language can be determined based on user language data for the receiving users in the ongoing communication session. Each user in a communication session can provide user language data indicating their communication language (i.e. the language in which they wish to receive output communication data) at, or prior to, the start of the communication session (e.g. during an account registration process, when starting the communication session, etc.). The user language data can include both user textual language data and user spoken or signed language data, e.g. to ensure that a transcript is generated in the correct textual language when the user uses/understands a signed language. This can ensure that the translation can be performed correctly for each receiving user. This may also facilitate the transcription process at 304, by identifying to the server 105 the language (optionally including a specified dialect) in which the user is likely to communicate when providing input communication data.

To facilitate the translation, a plurality of first transcript syntactic blocks can be identified in the input communication transcript. The plurality of first transcript syntactic blocks can then be translated into the second textual language block by block.

The translation can be performed using a translation machine learning model trained to operate as a natural language processing system. The translation machine learning model can be defined to receive as inputs a block of text (e.g. a first transcript syntactic block), an input language (e.g. the first written language), and an output language (e.g. the second written language). The translation machine learning model can be defined to output a block of text in the output language in response to receiving the block of text, input language and output language as inputs.

At 308, output communication data can be generated from the output communication transcript generated at 306. The output communication data can be defined in a second language that is different from the first language. The second language can be a second spoken language or a second signed language. As noted above, the second language can be identified by a receiving user prior to, or at the time of, participating in a communication session.

In some cases, the second language may be a second spoken language. The output communication data can be generated to include a synthesized voice speaking in the second spoken language. For example, the synthesized voice can be generated using a text-to-speech process, such as that provided by the gTTS library or the like.

Optionally, the synthesized voice can be generated based on a default voice. The default voice can be predefined by the system. Alternatively, the default voice may be selected by the first user (e.g. from one or more available default voice options). Further alternatively, the default voice may be selected by the second user (e.g. from one or more available default voice options).

Alternatively, the synthesized voice can be generated to reflect or clone the first user's voice (i.e. generated as a replica of the first user's voice). For example, the synthesized voice can be generated based on a first user voice sample received from the first user. The synthesized voice can be generated to provide a clone or replica of the first user's voice sample speaking in the second language instead of the first language used by the first user. This can help maintain the voice characteristics of the first user even once the communication data has been translated into a second language, providing for a more natural and personalized communication experience.

A synthesized voice that replicates the first user's voice can be generated by a first user machine learning model trained using the first user voice sample. The first user can provide one or more audio samples to their electronic device. The first user audio samples can be provided as training inputs to a deep learning model configured to operate as a voice cloning model. The trained model can then be used to generate speech in a cloned version of the first user's voice. For example, libraries such as Google WaveNet can be used to generate a model for voice cloning.

The first user machine learning model can be stored locally on the first electronic device. Optionally, the first user machine learning model can be stored solely on the first electronic device to reduce the opportunities for the first user's voice to be cloned without their consent.

Alternatively, the first user machine learning model may be stored by the server 105 to offload storage and processing from the first electronic device. This may ensure that the output communication data can be generated sufficiently quickly to enable and facilitate real-time communication.

Optionally, the output communication data can be defined at least partially based on emotion data detected in the input communication data. In traditional phone or video calls, it can be challenging to accurately gauge the emotional state of the other person, leading to misunderstandings or misinterpretations. This challenge is further heightened when the communication data has to be translated to allow for understanding, as much of the nuance in audio or non-verbal communication may be lost. Accordingly, the output communication data can be defined based on emotion data reflecting the first user's emotions to provide additional contextual communication information that can enhance the second user's understanding of the communication data being received. For instance, output audio data and/or output video data may be augmented based on emotion data detected from the input communication data.

Emotion data can be detected from the input communication data. The emotion data can include one or more input sentiment values (e.g. sadness, happiness, fear, anger, surprise, disgust etc.). The emotion data can also include a corresponding input intensity value for each of the identified sentiments. The emotion data can be used to generate the output communication data. For example, the synthesized voice may be modified based on the detected emotion data. Alternatively or in addition, the output communication data can be defined to include a visual representation of the emotion data (e.g. an emoji representation, a textual representation, a numeric representation) to convey to the receiving user the emotions detected when the first user was communicating.

As noted above, the input communication data can include audio input data. The audio input data can be used to determine first user verbal context data reflecting emotions expressed by the user as they speak.

First user audio features (e.g. pitch, tone, volume) can be extracted from the audio input data received at 302. For example, audio analysis libraries such as librosa can be used to extract the features from the audio input data. The extracted features may then be input to a machine learning model trained to detect emotion in audio data. Verbal emotion values can then be defined based on the output from the machine learning model.

Alternatively, the audio input data can be input directly to a machine learning model trained to detect emotion in audio data (i.e. without a distinct feature extraction pre-processing step).

Optionally, the audio input data can be separated into a plurality of audio input blocks. The plurality of audio input blocks can then be input to the machine learning model to detect the emotion data.

Alternatively or in addition, emotion data can be detected from video input data included in the communication data. The video input data can be used to determine first user non-verbal context data reflecting emotions expressed by the user through non-verbal cues. Non-verbal cues such as facial expressions play a crucial role in communication, especially in video calls. However, identifying and interpreting these cues in real-time can be difficult particularly as there may be a disconnect for the receiver between the video showing the first user communicating and the translated output communication data (e.g. due to differences in syntax, relative delays in transmission etc.).

The video input data can be analyzed to detect emotion data, for instance based on facial expressions of the first user. Facial characteristics of the first user can be identified in the video input data. For example, libraries such as OpenCV or MediaPipe may be used to capture the video input data and/or identify the first user's face in the video input data. The facial characteristics of the first user in the video input data can then be analyzed to detect video emotion data. The facial characteristics can be used to identify emotions (or expressions corresponding to emotions) being expressed by the first user.

The first user's facial characteristics can be analyzed by detecting facial landmarks (key points on the first user's face that typically correspond to facial features) of the first user in the video input data. For example, facial landmarks can be identified using various landmark detection methods such as those provided through the Dlib or OpenCV libraries. The identified facial landmarks can define first user facial landmark data. The first user facial landmark data can then be input to a facial characteristic machine learning model trained to video output emotion data based on facial landmarks. In particular, the facial characteristic machine learning model can be trained to output emotion data reflecting the emotions expressed by the first user (e.g. smiling, frowning). Optionally, the first user facial landmark data can be used to identify facial expressions that are in turn classified into emotion data by a trained machine learning model.

The output communication data can be defined to include first user non-verbal context data reflecting the non-verbal cues or expressions from the first user. For example, the non-verbal context data may be presented to a receiving user through text or other symbols (e.g. emojis, colors, symbols) that allow the receiving user to understand the non-verbal cues associated with the information contained in the output communication data in the second spoken language or second signed language.

In some embodiments, at least one of the first language or the second language can be a signed language. For example, the first language can be a signed language and the second language can be a spoken language. In another example, the first language can be a spoken language and the second language can be a signed language. In yet another example, the first language can be a first signed language (e.g. American Sign Language) and the second language can be a second signed language (e.g., Chinese Sign Language). In other embodiments, both the first language and the second language can be spoken languages. For example, the first language can be a first spoken language (e.g. English) and the second language can be a second signed language (e.g., Spanish).

At 310, the output communication data can be provided to a second electronic device associated with a second user. The output communication data can be defined to be usable by the second electronic device to output the output communication data in the second language.

Optionally, output communication data can be provided to one or more additional electronic devices. For example, where a communication session involves more than two participants, output communication data can be provided to each user (other than the first user) participating in the communication session. In some embodiments, a communication session can involve as many as 50 participants.

In some cases, a communication session may include participants who communicate using more than two different languages. Accordingly, steps 306-308 can be repeated/duplicated for each additional output language required by a participant in the communication session. Steps 306-308 can be performed substantially simultaneously (i.e. in parallel) for each additional output language. At least one additional output communication transcript can be generated. Each additional output communication transcript can be generated in a corresponding additional textual language by translating the input communication transcript from the first textual language to the additional textual language.

For each additional output communication transcript, corresponding additional output communication data can be generated in an additional language that is an additional spoken language or an additional signed language. In some cases, the same output communication transcript may be used to generate output communication data in multiple languages (e.g. where the same textual language is used to generate different signed output languages and/or the same textual language is used to generate a signed output language and a spoken output language). The additional output communication data can be provided to an additional electronic device associated with an additional user. The additional output communication data can be used by the additional electronic device to output the additional output communication data in the additional language.

Optionally, a selective forwarding unit (SFU) can be used to route the output communication data to respective users. For example, in the case of the same output communication transcript being used to generate output communication data in multiple languages, the SFU can route output communication data in a first language to a first user and output communication data in a second language to a second user. By routing output communication data to select users, the system 100/200 bandwidth can be managed more efficiently to avoid bandwidth saturation.

Optionally, the output communication transcript can also be transmitted to each receiving user (i.e. the second user device and any additional device) along with the output communication data at 310. This can provide the receiving user with a textual reference that corresponds to the content of the signed or spoken data provided to that user. Further, to avoid bandwidth saturation while also avoiding interference, output communication transcripts for different languages can be transmitted on separate channels. For example, the output communication transcript of a first language can be transmitted on a first channel and the output communication transcript of a second language can be transmitted on a second channel.

Optionally, the output communication transcript can be transmitted to each receiving user separately from the output communication data to minimize the effect of translation delays on the audio output data and/or video output data. For example, the output communication transcript can be transmitted using a different data transmission protocol from the output communication data. That is, the output communication data can be transmitted to a receiving user (i.e., user device 115) using a first data transmission protocol and the output communication transcript can be transmitted to the user device 115 using a second data transmission protocol.

Separate transmission of the output communication transcript and the output communication data can allow for better scalability. For example, the output communication transcript can be broadcast using a data communication protocol for one-way communication.

Optionally, the output communication data and the output communication transcript can include identifiers for synchronization. For example, the output communication data and the output communication transcript can each include timestamps prior to transmission to a receiving user (i.e. user device 115). Following transmission via separate channels, the user device 115 can use the timestamps to synchronize, or align the output communication data with the output communication transcript.

Optionally, the systems and methods described herein can be combined or integrated with augmented and/or virtual reality applications. The communication sessions managed through methods such as method 300 can be provided within augmented and/or virtual reality environments to provide users with a more immersive experience and/or to facilitate various implementations for remote assistance, training, and social interaction for example. For example, augmented reality libraries such as ARKit (iOS) or ARCore (Android) can be used to overlay virtual objects on the real-world video feed received as input communication data from each user. Alternatively, 3D virtual environments can be generated using tools such as Unity or Unreal Engine while still providing real-time translation for users within the virtual environment.

As used herein, the wording “and/or” is intended to represent an inclusive—or. That is, “X and/or Y” is intended to mean X or Y or both, for example. As a further example, “X, Y, and/or Z”is intended to mean X or Y or Z or any combination thereof.

While the above description describes features of examples, it will be appreciated that some features and/or functions of the described examples are susceptible to modification without departing from the spirit and principles of operation of the described examples. For example, the various characteristics which are described by means of the represented examples or examples may be selectively combined with each other. Accordingly, what has been described above is intended to be illustrative of the claimed concept and non-limiting. It will be understood by persons skilled in the art that other variants and modifications may be made without departing from the scope of the invention as defined in the claims appended hereto. The scope of the claims should not be limited by the preferred examples and examples, but should be given the broadest interpretation consistent with the description as a whole.

1-20. (canceled)

21. A system for providing real-time communication between a plurality of users communicating in a plurality of languages, wherein each user is associated with a corresponding electronic device, the system comprising:
a first electronic device associated with a first user;
a second electronic device associated with a second user; and
a server in communication with the first electronic device and the second electronic device;
wherein the first electronic device is configured to receive input communication data comprising the first user communicating in a first language, wherein the first language is a first spoken language or a first signed language;
at least one of the first electronic device or the server is configured to:
generate, from the input communication data, an input communication transcript in a first textual language;
generate an output communication transcript in a second textual language by translating the input communication transcript from the first textual language to the second textual language, wherein the second textual language is different from the first textual language;
generate, from the output communication transcript, output communication data in a second language wherein the second language is a second spoken language or a second signed language; and
the server is configured to provide the output communication data to the second electronic device, wherein the output communication data is usable by the second electronic device to output the output communication data in the second language, and at least one of the first language is a first signed language or the second language is a second signed language.

22. The system of claim 21, wherein the input communication data includes audio input data comprising the first user communicating in the first spoken language captured by the first electronic device.

23. The system of claim 22, wherein the first textual language is a written form of the first spoken language.

24. The system of claim 21, wherein the input communication data includes video input data comprising the first user communicating in the first signed language captured by the first electronic device.

25. The system of claim 24, wherein the at least one of the first electronic device or the server is configured to generate the input communication transcript by analyzing the video input data to detect signed communication content of the first user communicating in the first signed language and translating the signed communication content into the first textual language.

26. The system of claim 25, wherein the first textual language is preselected by the first user.

27. The system of claim 25, wherein the at least one of the first electronic device or the server is configured to analyze the video input data to detect the signed communication content by inputting at least a portion of the video input data to a machine learning model trained to detect hand gestures associated with the first signed language.

28. The system of claim 21, wherein the at least one of the first electronic device or the server is configured to translate the input communication transcript from the first textual language to the second textual language by:
identifying a plurality of first transcript syntactic blocks in the input communication transcript; and
translating the plurality of first transcript syntactic blocks into the second textual language block by block.

29. The system of claim 21, wherein the second language is a second spoken language and the at least one of the first electronic device or the server is configured to generate the output communication data by generating a synthesized voice speaking in the second spoken language.

30. The system of claim 29, wherein the synthesized voice is generated based on a first user voice sample received from the first user.

31. The system of claim 30, wherein the synthesized voice is generated by a first user machine learning model trained using the first user voice sample.

32. The system of claim 31, wherein the first user machine learning model is stored locally on the first electronic device.

33. The system of claim 29, wherein the at least one of the first electronic device or the server is configured to:
detect emotion data from the input communication data; and
modify the synthesized voice based on the detected emotion data.

34. The system of claim 33, wherein the input communication data includes audio input data and the at least one of the first electronic device or the server is configured to detect the emotion data in the input communication data by:
separating the audio input data into a plurality of audio input blocks;
inputting the plurality of audio input blocks to a machine learning model trained to detect emotion in audio data; and
defining emotion values based on the output from the machine learning model.

35. The system of claim 33, wherein the at least one of the first electronic device or the server is configured to detect the emotion data by determining an input sentiment value and an input intensity value.

36. The system of claim 33, wherein the input communication data includes video input data and the at least one of the first electronic device or the server is configured to detect the emotion data in the input communication data by:
analyzing facial characteristics of the first user in the video input data to detect video emotion data.

37. The system of claim 36, wherein the at least one of the first electronic device or the server is configured to analyze the facial characteristics of the first user by:
defining first user facial landmark data by detecting facial landmarks of the first user in the video input data; and
inputting the first user facial landmark data to a machine learning model trained to output the video emotion data based on facial landmarks.

38. The system of claim 21, wherein the at least one of the first electronic device or the server is configured to:
generate at least one additional output communication transcript, wherein each additional output communication transcript is generated in a corresponding additional textual language by translating the input communication transcript from the first textual language to the additional textual language;
for each additional output communication transcript, generate corresponding additional output communication data in an additional language wherein the additional language is an additional spoken language or an additional signed language; and
the server is configured to provide the additional output communication data to an additional electronic device associated with an additional user, wherein the additional output communication data is usable by the additional electronic device to output the additional output communication data in the additional language.

39. The system of claim 38, wherein the server is configured to, for each additional output communication transcript, provide the additional output communication transcript in the corresponding additional textual language to the additional electronic device associated with the additional user using a different channel of a data transmission protocol used for providing the output communication transcript in the second textual language to the second electronic device.

40. The system of claim 21, wherein the server is configured to provide the output communication transcript to the second electronic device associated with the second user using a different data transmission protocol than a data transmission protocol used for providing the output communication data to the second electronic device.

41-44. (canceled)
